(19) United States
(12) Patent Application Publication
(10) Pub. No.: US 2008/0268991 A1
(43) Pub. Date: Oct. 30, 2008

(54) Method for producing a conical pulley, a conical pulley, and a belt-driven conical-pulley transmission

(75) Inventor: Bernhard Walter, Oberkirch-Haslach (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 12/080,259

(22) Filed: Apr. 1, 2008

Related U.S. Application Data
(60) Provisional application No. 60/921,350, filed on Apr. 2, 2007.
(60) Provisional application No. 60/923,968, filed on Apr. 18, 2007.

(51) Int. Cl. F16H 55/36; B21K 1/22

(52) U.S. Cl. 474/12; 29/892.11; 474/8

(57) ABSTRACT

Rotatable conical disks for a belt-driven conical-pulley transmission. The conical disks have conical surfaces that inclined relative to a conical disk axis of rotation and have surfaces that are induction hardened together with or separate from a shaft component. The induction hardened surfaces of the conical disks include regions of the disk surfaces that are frictionally engaged by an endless torque-transmitting component. The shaft component is induction hardened in regions that experience high mechanical stresses as a result of axial loads imposed on the conical surfaces of the disks by the endless torque-transmitting component.

### BACKGROUND OF THE INVENTION

1. Field of the Invention

The present invention relates to a method for producing a conical pulley for a belt-driven conical-pulley transmission, to a conical pulley for a belt-driven conical-pulley transmission, and to a belt-driven conical-pulley transmission that includes such a conical pulley.

2. Description of the Related Art

The use of belt-driven conical-pulley transmissions, which allow a continuously variable transmission ratio adjustment, was limited for a long time to vehicles having engines with low torque output. Modern, further advanced belt-driven conical-pulley transmissions can transfer torques of over 300 Nm, so that such belt-driven conical-pulley transmissions are now also being used with high-torque-output engines and in high-powered vehicles, in particular in passenger cars.

FIG. 4 shows a pair of conical disks of a belt-driven conical-pulley transmission, whose general configuration is known. The illustrated embodiment of a conical disk pair of the known belt-driven conical-pulley transmission includes an input shaft 10 that is provided with an integrally formed, axially fixed disk 12. An axially movable disk 14 includes a hollow stub shaft 16 that is non-rotatably connected with but axially movable relative to the input shaft 10 by means of a spline connection 18, provided on the outside of the input shaft 10, and on the inside of the stub shaft 16. The spline connection includes axially-extending projections and grooves or recesses.

An input pinion 20 that is driven by an internal combustion engine (not shown) is supported on the input shaft 10, and non-rotatably connected with a torque sensor unit 22. Input pinion 20 transmits the input torque to the axially movable disk 14, which influences the axial adjustment of the axially movable disk 14, which is performed by hydraulic pressure.

The additional details and the function of the illustrated embodiment are not further described herein because they are known in principle. An endless torque-transmitting means 34 runs between the conical disks 12 and 14 and another conical disk pair that is disposed at radial distance from the illustrated conical disk pair. The transmission ratio of the belt-driven conical-pulley transmission is changed by opposite adjustment of the axial distances between the conical disks of the conical disk pairs.

The conical pulleys and the axle components connected therewith are highly stressed mechanically in certain operating regions. Thus, conical surfaces of the conical disks that face each other are stressed with respect to their strength and also with respect to wear, as a consequence of their frictional engagement with the endless torque-transmitting means. Thus, the spline connected portions, the left end portion of the hollow shaft section 16 illustrated in FIG. 4, and the portion of the input shaft adjacent to it in the direction toward the input pinion are highly stressed.

It is furthermore known to case harden in particular the above-mentioned portions, similar to regular transmission components, e.g., shafts or gears. Because the conical disks and their associated shaft components have a significant volume and are bulky components, case hardening is expensive due to the complex oven loading process and due to the long carbonization times.

It is an object of the present invention to reduce the cost associated with the manufacture of a belt-driven conical-pulley transmission, without degradation of the functional quality.

### SUMMARY OF THE INVENTION

The object is achieved by a method for producing a conical disk for a belt-driven conical-pulley transmission, by which method at least partial portions of the surface of the conical disk are hardened, and wherein other partial portions of the surface of the conical disk are induction hardened.

In the known induction hardening method, the surface portions of the conical disk to be hardened are heated by an induction coil, wherein the depth of hardening and the temperature can be adjusted. Induction hardening can also be performed cost effectively on components that are complex and that have a significant volume in a manner that is adapted to the special requirements of the components.

The cost can be reduced further by machining at least partial portions of the hardened portions to a finish before hardening, so that no machining is required after hardening.

Another solution to the object of the present invention is achieved for a conical disk for a belt-driven conical-pulley transmission in which a conical surface of a conical disk of the conical pulley, provided for frictional engagement with an endless torque-transmitting means, is induction hardened.

The axially movable conical disk includes a coaxial stub shaft that includes a through-opening for sliding the axially movable conical pulley onto a shaft, wherein the inside of the through-opening is provided with axial recesses and/or axial projections for an axially movable and non-rotatable connection with the shaft, and is induction hardened at least in the region of the axial recesses and/or axial projections.

It is advantageous for the surface of the above-described conical disk to be induction hardened in further surface regions that are exposed to particularly high mechanical stresses.

The conical disk and the stub shaft can be made from different materials and connected to each other in a rigid manner.

The axially fixed conical disk can include a shaft on which the stub shaft of the axially movable conical disk is slidably received, wherein the outer surface of the shaft is provided with recesses and/or projections for an axially movable and non-rotatable connection with the hollow stub shaft, and can be induction hardened in at least the region of the recesses and/or projections.

It is advantageous for the surface of the conical disk to be induction hardened on additional mechanically highly stressed surface portions.

The conical disk and the shaft can be made of different materials and can be rigidly connected to each other.

Particular degrees of freedom with respect to hardening arise as a result when the conical pulley includes a conical disk and a shaft component, each of which is made of a different material and is hardened differently.

A belt-driven conical-pulley transmission having conical disks and whose conical surfaces are induction hardened, is preferably operated with a rocker joint chain, that is, a plate-link chain, as an endless torque-transmitting means, whose pressure piece end surfaces are in frictional engagement with the induction hardened conical surfaces.

The end surfaces of the pressure pieces can include a planar surface inclined at an angle of between 6° and 13° to the axis of rotation, preferably 11°, corresponding approximately to the conical angle, relative to the axis of rotation, of the conical surfaces of the conical disks.

Alternatively, the end surfaces of the pressure pieces can be of convex or spherical form.

### BRIEF DESCRIPTION OF THE DRAWINGS

The structure, operation, and advantages of the present invention will become further apparent upon consideration of the following description, taken in conjunction with the accompanying drawings in which:

FIG. 1 is a longitudinal cross-sectional view of an axially movable conical disk forming part of a conical pulley;

FIG. 2 is a longitudinal cross-sectional view of a an axially fixed conical disk forming part of a conical pulley;

FIG. 3 is a longitudinal cross-sectional view showing of an embodiment of an axially fixed conical disk in accordance with the present invention; and

FIG. 4 is a longitudinal sectional view of a known conical disk pair of a belt-driven conical-pulley transmission.

### DESCRIPTION OF THE PREFERRED EMBODIMENTS

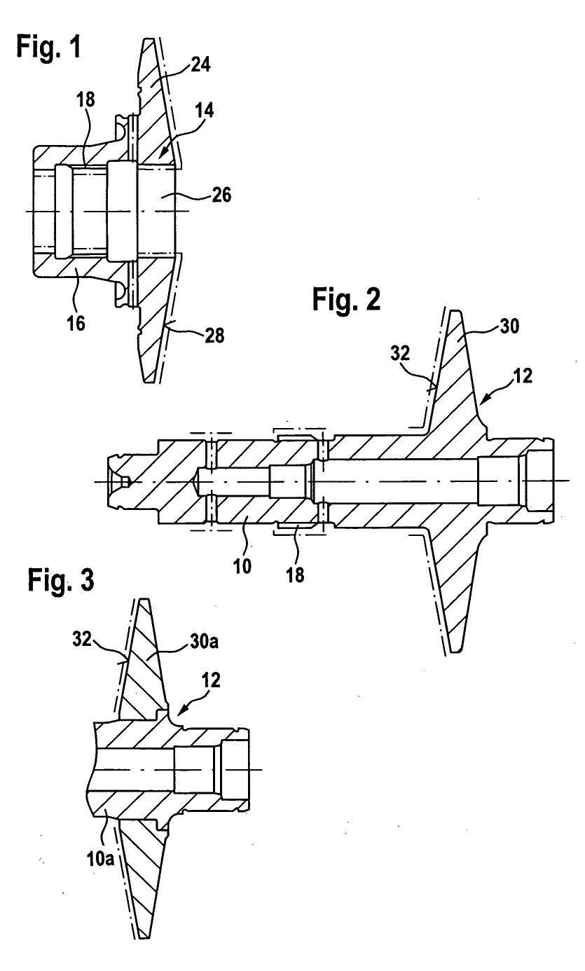

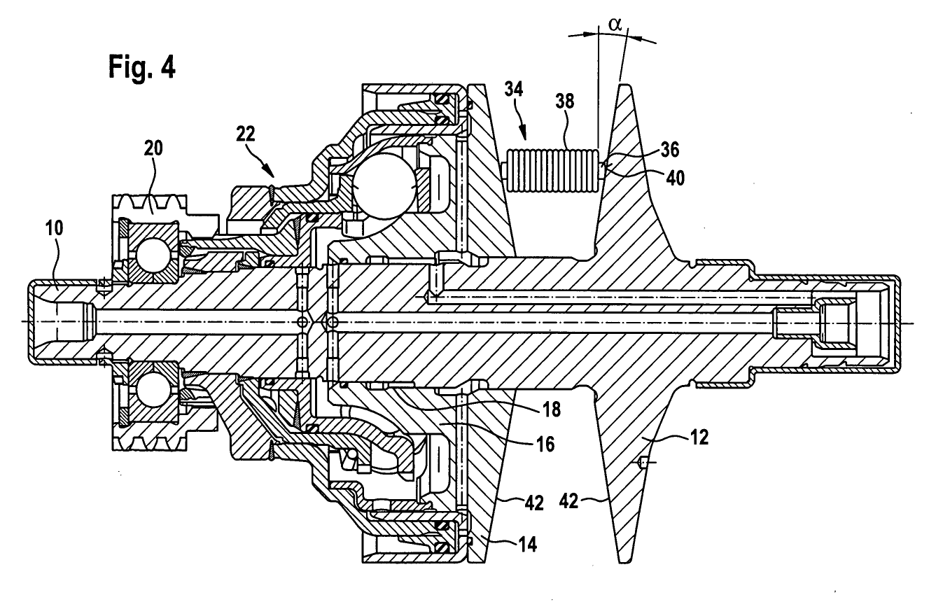

FIG. 1 shows a longitudinal cross-sectional view of an axially movable disk 14, which is configured similar to the known axially movable disk described with reference to FIG. 4. The axially movable disk 14 is developed from a conical pulley disk 24 and a hollow stub shaft 16 that is integrally formed with the conical pulley disk 24. The stub shaft 16 includes axially extending grooves or projections and recesses at the inner surface of its pass-through opening 26, which forms a spline connection 18. The surface portions of the axially movable disk 14 that are preferably inductively hardened as functional portions are shown in a dot and dash line, namely the conical surface 28 that is stressed by the endless torque-transmitting means, as well as those portions of the pass-through opening 26 that directly contact the outer surface of the input shaft (see FIG. 4), as well as the radial inner surface of the conical disk pulley 24, the region of the spline 18, and the left end portion of the pass-through opening 26, extending radially inward as shown in FIG. 1, which is pressed into firm contact with the radially outer surface of the input shaft 10 when strong forces act perpendicular to the conical surface 28. The identified functional regions can be induction hardened in a different manner depending upon their loading.

FIG. 2 shows a longitudinal cross-sectional view of an axially fixed disk 12 with a similar configuration as the axially fixed disk shown in FIG. 4. The axially fixed disk 12 includes a conical pulley disk 30 and the input shaft 10, which is integrally formed with the conical pulley disk 30. Similar to FIG. 1, the particularly stressed surface portions of the axially fixed disk 12 are induction hardened, thus the conical surface 32 of the conical pulley disk, the region of the outer surface of the input shaft 10 that is provided with projections and recesses or grooves for providing the spline 18 and in which the non-rotatable but axially adjustable engagement between the axially movable disk 14 and the axially fixed disk 12 takes place, and a region to the left of the spline connection 18, at which a component of the torque sensor unit 22 (see FIG. 4) is directly disposed on the input shaft 10 and is axially movable relative to it. Again, the hardening of those regions that are shown in dash dot lines can be adapted to the stress in an optimum manner, depending upon their function, and can be induction hardened to a different extent.

FIG. 3 shows a fragmentary detail of FIG. 2, in which the conical pulley disk 30a and the input shaft 10a, which is only partially shown, are made of different materials and are subsequently rigidly connected, by shrink fitting, for example. The input shaft 10a can be made of steel, for example, which can be case hardened especially well. The conical pulley disk 30a can be made of a carbon steel, which can be induction hardened especially well. Advantageously, particularly the induction hardened conical surface 32 and the conical surface 28 of the axially movable disk are not machined any further after induction hardening.

It will be appreciated that the axially movable disk 14 can also be assembled from two different materials that are adapted to the respective requirements and hardened in an optimum manner.

By providing the conical pulleys as conical pulley disks and shaft components initially from different materials, the shaft components can be easily case hardened because of their simple configuration, and they can be connected with the conical pulley disks in a rigid manner after hardening, wherein conical pulley disks are induction hardened either previously or subsequently.

When in the belt-driven conical-pulley transmission that has been previously described, as it has been developed by the applicant of the present patent application and whose general configuration is known, the conical surfaces of its conical pulleys 12 and 14 are induction hardened, in particular in conjunction with a rocker joint chain 34 (also referred to as a plate-link chain), provides excellent operating characteristics, such as long service life, torque-transmitting capacity, and the like. Such a rocker joint chain 34 includes pressure pieces 36 that are connected by particular link plates 38 that extend in the in longitudinal direction of the rocker joint chain 34, wherein the pressure pieces 36 roll in a rocking movement within the link plates 38 when the rocker joint chain 34 is curved. The end surfaces 40 of the pressure pieces 36 are in frictional engagement with the conical surfaces 42 of the conical disks 12 and 14. Preferably, conical angles α (see FIG. 4) between 6° and 13°, in particular 11°, are machined, wherein the end surfaces can be configured as planar conical surfaces, and the conical angle of the end surfaces can be slightly smaller than the conical angles of the conical surfaces of the disks.

It is preferred to form the end surfaces convexly or spherically, so that there is no risk of an overload at their edges.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for producing a conical disk for a belt-driven conical-pulley transmission, said method comprising the steps of: providing a rotatable disk having a conical surface that is inclined relative to a plane that is perpendicular to a disk axis of rotation; and induction hardening of at least partial portions of the conical surface of the rotatable disk.

2. A method in accordance with claim 1, including the step of machining at least partial portions of the conical surface to a predetermined surface finish before hardening.

3. A conical disk for a belt-driven conical-pulley transmission, said disk comprising: a rotatable disk having a conical surface that is inclined relative to a plane that is perpendicular to a disk axis of rotation and that includes a conical surface region that is frictionally engaged by an endless torque-transmitting means of a belt-driven conical-pulley transmission, wherein the conical surface region that is frictionally engaged by the endless torque-transmitting means is induction hardened.

4. A conical disk in accordance with claim 3, wherein the conical disk includes a stub shaft that is coaxial with the disk axis of rotation and includes a through-opening for sliding the stub shaft onto a drive shaft, wherein an inner surface of the through-opening includes axially-extending engagement means for axially movable and non-rotatable connection with the drive shaft, and wherein the stub shaft is induction hardened at least in the region of the engagement means.

5. A conical disk in accordance with claim 4, wherein the inner surface of the through-opening is induction hardened on additional surface regions that are subjected to mechanical stresses as a result of axial loads imposed on the conical disk by the endless torque-transmitting means.

6. A conical disk in accordance with claim 4, wherein the conical disk and the stub shaft are each made of different materials and are rigidly connected to each other.

7. A conical disk in accordance with claim 3, wherein the conical disk includes a shaft that is coaxial with the conical disk for slidably receiving a hollow stub shaft, wherein an outer surface of the shaft is includes axially-extending engagement means for axially movably and non-rotatably receiving the hollow stub shaft, and wherein the outer surface of the shaft is induction hardened at least in the region of the axially-extending engagement means.

8. A conical disk in accordance with claim 7, wherein the outer surface of the shaft is induction hardened at additional surface regions that are subjected to mechanical stresses as a result of loads imposed on the outer surface of the shaft as a result of axial loads imposed on the conical disk by the endless torque-transmitting means.

9. A conical disk in accordance with claim 7, wherein the conical disk and the shaft are made of different materials and are rigidly connected with each other.

10. A conical disk in accordance with claim 3, wherein the conical disk includes a shaft component, wherein the conical disk and shaft component are made of different materials and are hardened to different surface hardness levels.

11. A belt-driven conical-pulley transmission with pairs of axially opposed conical disks in accordance with claim 3 that are drivingly interconnected by an endless torque-transmitting means, whose induction hardened conical surface regions are in frictional engagement with conically inclined end surfaces of pressure pieces of a rocker joint chain.

12. A belt-driven conical-pulley transmission in accordance with claim 11, wherein the end surfaces of the pressure pieces include an inclined planar surface having an inclination angle of between 6° and 13° relative to a transverse plane that is perpendicular to the disk axis of rotation to correspond approximately to a conical inclination angle of the conical surfaces relative to the transverse plane that is perpendicular to the disk axis of rotation.

13. A belt-driven conical-pulley transmission in accordance with claim 11, wherein the end surfaces of the pressure pieces are convex.

14. A belt-driven conical-pulley transmission in accordance with claim 12, wherein the inclination angle of the end surfaces of the pressure pieces is 11°.
